(19) United States
(12) Patent Application Publication
(10) Pub. No.: US 2007/0177366 A1
(43) Pub. Date: Aug. 2, 2007

(54) Alignment and coupling of electronics housings to electric machines

(76) Inventors: William P. Stewart, St. Charles, MO (US); Timothy Druhe, Granite City, IL (US); David M. Lyle, O'Fallon, MO (US)

Correspondence Address: HARNESS, DICKEY, & PIERCE, P.L.C, 7700 BONHOMME, STE 400, ST. LOUIS, MO, 63105, US

(21) Appl. No.: 11/342,077

(22) Filed: Jan. 27, 2006

(51) Int. Cl. H02K 5/00; H01R 12/16

(52) U.S. Cl. 361/791; 310/89

(57) ABSTRACT

An electric machine assembly includes an electronics housing, a machine housing, one of a tab and a slot located on the electronics housing, and the other of said tab and slot located on the machine housing. The tab is positioned to engage the slot for aligning the electronics housing with the machine housing. The slot can optionally include an alignment portion and a coupling portion. After the tab is positioned in the alignment portion, the electronics housing can be rotated relative to the machine housing to engage the tab with the coupling portion and thereby couple the housings together.

### FIELD

The present disclosure relates generally to electric machine assemblies having an electronics housing coupled to an electric machine housing.

### BACKGROUND

The statements in this section merely provide background information related to the present disclosure and may not constitute prior art.

Various electric machine assemblies are known in which an electronics housing containing control electronics for an electric machine (a motor or generator) is coupled directly to a housing of the electric machine. In some cases, the electronics housing is referred to as a “can” that is removably coupled to an endshield of an electric motor. Typically, the electronics housing is coupled to the motor housing using several screws. As recognized by the present inventors, however, these screws are often difficult to access once the. motor is installed in a particular application. If the screws can be accessed and removed, there is a risk the screws will be dropped (into the motor, the control electronics, or other equipment) and/or lost. Further, it can be difficult to align the screw holes in the electronics housing with the screw holes in the motor housing as necessary to install the screws. Further still, the screws are often insufficient to prevent the electronics housing from vibrating on the motor housing and generating noise during motor operation.

### SUMMARY

According to one aspect of this disclosure, an electric machine assembly includes an electronics housing, a machine housing, one of a tab and a slot located on the electronics housing, and the other of said tab and said slot located on the machine housing. The tab is positioned to engage the slot for aligning the electronics housing with the machine housing.

According to another aspect of this disclosure, a method for removably coupling an electronics housing to an electric machine housing using a tab positioned on one of said housings and a slot positioned on the other of said housings includes positioning the electronics housing adjacent the machine housing, and engaging the tab with the slot.

According to yet another aspect of this disclosure, a variable speed blower assembly for a climate control system includes a variable speed electric motor having at least one end shield, an electronics housing, control electronics positioned in the electronics housing, and a plurality of tab-slot pairs. Each pair includes a tab located on one of the end shield and the electronics housing and a slot located on the other of said end shield and electronics housing. The tabs are positioned to engage the slots for aligning the electronics housing with the machine housing.

According to still another aspect of this disclosure, an electric motor and controller assembly includes an electric motor having a motor housing and an electronics housing containing electronics for controlling the electric motor. The electronics housing is configured for removable coupling to the motor housing by rotating the electronics housing relative to the motor housing.

Further aspects of the present disclosure will be in part apparent and in part pointed out below. It should be understood that various aspects of the disclosure may be implemented individually or in combination with one another. It should also be understood that the detailed description and drawings, while indicating certain specific embodiments of the invention, are intended for purposes of illustration only and should not be construed as limiting the scope of this disclosure.

### DRAWINGS

The drawings described herein are for illustration purposes only and are not intended to limit the scope of the present disclosure in any way.

FIG. 1 is a front view of an electric machine assembly according to a first embodiment.

FIG. 2A is an exploded front view of an electric machine assembly with an L-shaped slot according to another embodiment.

FIG. 2B is an assembled front view of the electric machine assembly of FIG. 2A.

FIG. 3 is a partial side view of an electric machine assembly with a locking projection according to another embodiment.

FIG. 4 is a partial side view of an electric machine assembly with a shoulder according to another embodiment.

FIG. 5 is a partial side view of an electric machine assembly with a fastener according to another embodiment.

FIG. 6A is a perspective view of a variable speed electric machine assembly according to another embodiment.

FIG. 6B is a reverse perspective view of the variable speed electric machine assembly of FIG. 6A.

FIG. 7 is a block diagram of a climate control system according to another embodiment.

Corresponding reference numerals indicate like parts or features throughout the drawings.

### DETAILED DESCRIPTION

The following description is merely exemplary in nature and is not intended to limit the present disclosure, application, or uses.

An electric machine assembly according to one embodiment of the present disclosure is illustrated in FIG. 1 and indicated generally by reference number 100. As shown in FIG. 1, the assembly 100 includes an electronics housing 102 and an electric machine housing 104. A tab 106 is positioned on the machine housing 104 and a slot 108 is provided on the electronics housing 102. The tab 106 is positioned to engage the slot 108 for aligning the electronics housing 102 with the machine housing 104, as illustrated in FIG. 1.

Although the tab 106 is positioned on the machine housing 104 and the slot 108 is positioned on the electronics housing 102 in the embodiment of FIG. 1, it should be understood that, in other embodiments, the tab 106 could be positioned on the electronics housing 102 and the slot could be provided on the machine housing 104. Further, while the tab 106 and the slot 108 each have a generally rectangular configuration, a wide variety of other tab and/or slot configurations can be employed, as will be apparent from the description below.

Although only one tab and one slot is shown in FIG. 1, the assembly 100 may be provided with multiple tab-slot pairs for aligning the electronics housing 102 with the machine housing 104.

The tab 106 can be formed integrally or separately from the machine housing (or the electronics housing, where the tab is positioned thereon), and can be, for example, a fastener such as a screw, bolt, rivet, etc., a post, or another tapered or untapered protuberance configured for engaging a corresponding slot.

Once the electronics housing 102 is positioned on the machine housing 104 with the tab 106 engaging the slot 108, the electronics housing 102 can be coupled to the machine housing 104 using one or more (preferably captive) fasteners. Alternatively (or additionally), the tab 106 and slot 108 could be configured for removably coupling the electronics and machine housings together, as will be apparent from the description below.

The electronics housing 102 contains control electronics (not shown) for an electric machine (an electric motor or generator) contained within the machine housing 104.

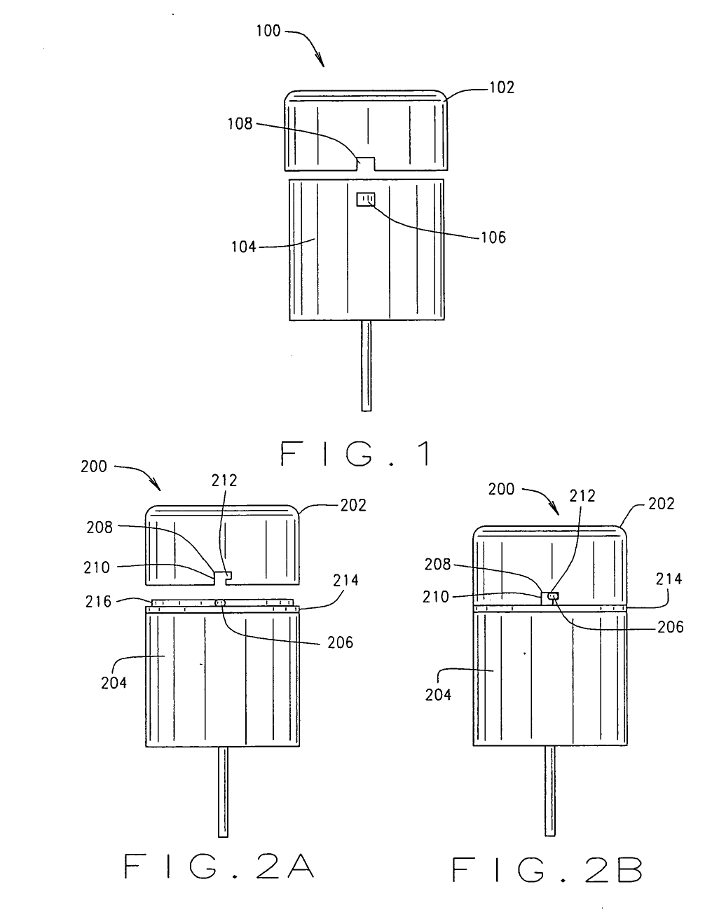

FIGS. 2A and 2B illustrate an electric machine assembly 200 according to another embodiment. Similar to the embodiment of FIG. 1, the assembly 200 includes an electronics housing 202 provided with a slot 208, and a machine housing 204 provided with a tab 206. Specifically, the machine housing 204 includes an end shield 214, and the tab 206 is positioned on the end shield 214, as shown in FIGS. 2A and 2B.

In the embodiment of FIGS. 2A and 2B, the slot 208 includes an alignment portion 210 and a coupling portion 212. The alignment portion 210 cooperates with the tab 206 in a manner similar to FIG. 1 for aligning the electronics housing 202 with the machine housing 204. Once the electronics housing 202 is positioned on a shoulder 216 of the end shield 214 with the tab 206 positioned in the alignment portion 210, the electronics housing 202 can be rotated relative to the machine housing 204 to engage the tab 206 with the coupling portion 212 of the slot 208, as shown in FIG. 2B. With the tab 206 positioned in the coupling portion 212 of the slot 208, the electronics housing 202 is removably coupled to the machine housing 204 and cannot be removed from the machine housing 204 without first rotating the electronics housing 202 as necessary to disengage the tab 206 from the coupling portion 212 of the slot 208. In the embodiment shown in FIGS. 2A and 2B, a shaft extends from one end of the machine housing 204, and the electronics housing 202 is removably coupled to the opposite end of the machine housing 204.

The tab 206 and the coupling portion 212 can be dimensioned to provide a tight or interference fit therebetween for securely holding the electronics housing 202 against the machine housing 204 to inhibit vibration and noise. Alternatively (or additionally), one or more (preferably captive) fasteners can be used to couple the electronics housing 202 to the machine housing 204, and/or to prevent unintended counter rotation of the electronics housing 202 relative to the machine housing 204 (which could result in disengagement of the tab 206 from the coupling portion 212 of the slot 208).

Although the embodiment of FIGS. 2A and 2B include the tab 206 and the slot 208 for removably coupling the electronics housing 202 to the machine housing 204 by rotating the electronics housing 202 relative to the machine housing 204, it should be understood that other means can be employed. For example, and as one alternative to tab-slot pair(s), threads could be provided on the housings 202, 204 such that the electronics housing 202 can be removably coupled to the machine housing 204 by rotating the electronics housing relative to the machine housing with the threads of the two housings 202, 204 engaging one another.

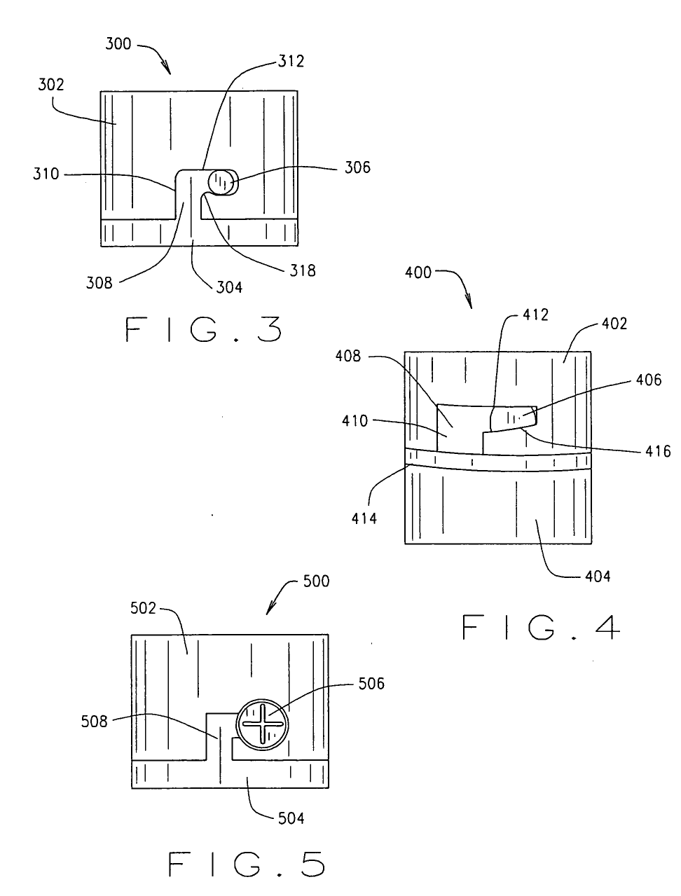

In the embodiment of FIGS. 2A and 2B, the alignment portion 210 is oriented perpendicular to the coupling portion 212 such that the slot 208 is L-shaped. It should be understood, however, that other slot configurations can be employed without departing from the scope of this disclosure. FIGS. 3-5 illustrate some alternative tab and slot configurations.

As illustrated in FIG. 3, the coupling portion 312 of a slot 308 can be configured to inhibit removal of the tab 306 therefrom to provide a locking function. In the particular embodiment shown in FIG. 3, the coupling portion 312 includes a projection 318 adjacent the alignment portion 310. By inhibiting disengagement of the tab 306 from the coupling portion 312, the projection 318 inhibits unintended rotation of the electronics housing 302, which could otherwise result in separation of the electronics housing 302 from the machine housing 304 (unless the electronics housing 302 was also coupled to the machine housing 304 via one or more fasteners).

FIG. 4 illustrates a tapered tab 406 and a tapered slot 408 according to another embodiment. Specifically, the coupling portion 412 of the slot 408 is tapered so that as the electronics housing 402 is rotated (to the left, in FIG. 4), the tab forces the electronics housing 402 toward and against the machine housing 404 to securely couple the housings together. In this particular embodiment, the tab 406 and the coupling portion 406 have matching tapers 416. In other embodiments, the tab and the slot can have dissimilar tapers, or only one of the tab and the slot may be tapered.

FIG. 5 illustrates another embodiment in which a threaded screw 506 serves as a tab for engaging an L-shaped slot 508 having alignment and coupling portions. After the electronics housing 502 is rotated to position the screw 506 in the coupling portion, the screw can be tightened to secure the position of the electronics housing 502 relative to the machine housing 504.

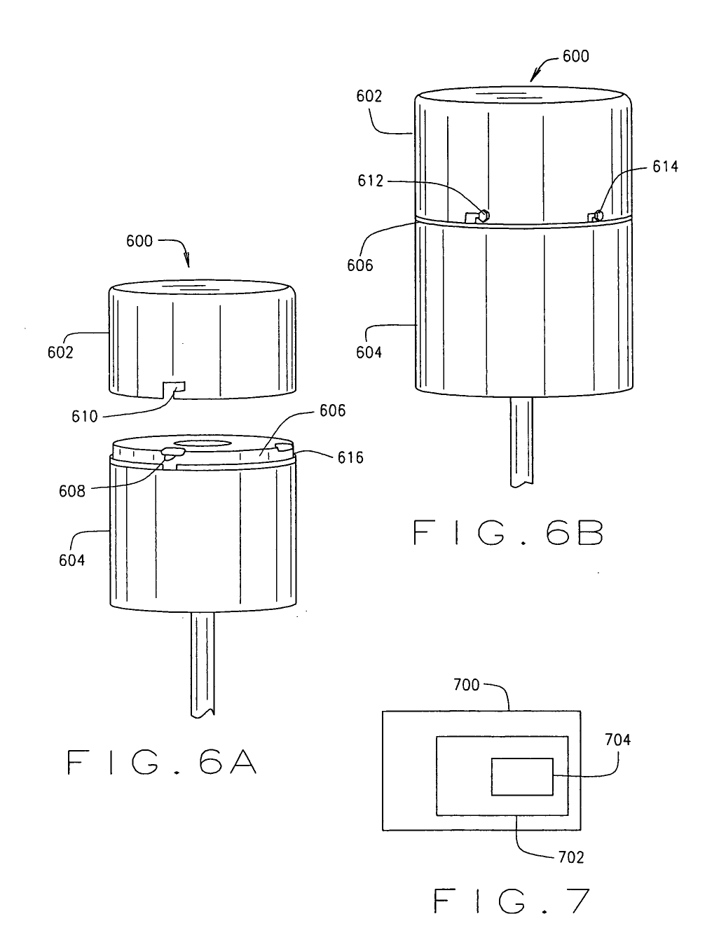

FIGS. 6A and 6B illustrates an electric machine assembly 600 according to another embodiment. The assembly 600 includes an electronics housing 602 containing control electronics (not shown) for a variable speed electric motor. The assembly further includes a variable speed electric motor 604 having an end shield 606. The electronics housing 602 can be removably coupled to the end shield 606 via three tab-slot pairs. The tabs are positioned on the end shield 606 adjacent a shoulder 616, and the slots are provided on the electronics housing 602. Each slot includes an alignment portion and a coupling portion and is generally L-shaped. One of the tabs 608 and one of the slots 610 (both shown in FIG. 6A) are tapered. Threaded screws 612, 614 are employed as tabs in the other two tab-slot pairs, shown in FIG. 6B.

Once the tabs are positioned in the alignment portions of the slots, the electronics housing 602 can be rotated to engage the tabs with the coupling portions. This rotation of the electronics housing 602 relative to the end shield 606 forces the electronics housing against the shoulder 616 of the end shield 606, due to the tapered tab 608 and slot 610. The threaded screws 612, 614 can then be tightened to secure the position of the electronics housing 602 relative to the end shield 606.

FIG. 7 illustrates a climate control system 700 according to another embodiment. The climate control system 700 includes a variable speed blower 702 (also referred to as an air handler). The variable speed blower 702 includes an electric machine assembly 704. Any of the electric machine assemblies described above with reference to FIGS. 1-6 can be employed as the electric machine assembly in FIG. 7.

1. An electric motor assembly for driving a component in an HVAC system, the assembly comprising an electronics housing, a motor housing, one of a tab and a slot located on the electronics housing, and the other of said tab and said slot located on the motor housing, the tab being positioned to engage the slot for aligning the electronics housing with the motor housing.

2. The assembly of claim 1 wherein the tab and the slot are adapted for removably coupling the electronics housing to the motor housing when the tab engages the slot.

3. The assembly of claim 2 wherein the slot includes an alignment portion and a coupling portion, the tab engaging the coupling portion after the tab is positioned in the alignment portion and the electronics housing is rotated relative to the motor housing.

4. The assembly of claim 3 wherein the slot has a generally L-shaped configuration.

5. The assembly of claim 3 wherein at least one of the tab and the slot includes a tapered portion for forcing the electronics housing against the motor housing after the tab is positioned in the alignment portion and the electronics housing is rotated relative to the motor housing.

6. The assembly of claim 5 wherein the tab and the slot have complementary tapered portions.

7. The assembly of claim 3 wherein the coupling portion is configured to inhibit removal of the tab from the coupling portion.

8. The assembly of claim 1 wherein the tab comprises a fastener for releasably securing the electronics housing to the motor housing by tightening the fastener after the fastener engages the slot.

9. The assembly of claim 1 wherein the assembly includes a plurality of tab-slot pairs, each pair including one of a tab and a slot located on the electronics housing and the other of said one of a tab and a slot located on the motor housing.

10. The assembly of claim 9 wherein each tab comprises a fastener or a post.

11. The assembly of claim 1 wherein one of the electronics housing and the motor housing has a peripheral shoulder for engaging a peripheral edge of the other of said electronics housing and said motor housing when the electronics housing is coupled to the motor housing.

12. A climate control system comprising the electric motor assembly of claim 1.

13. A method for removably coupling an electronics housing to an electric motor housing in an HVAC system using a tab positioned on one of said housings and a slot positioned on the other of said housings, the method comprising positioning the electronics housing adjacent the motor housing, and engaging the tab with the slot.

14. The method of claim 13 wherein the tab comprises a fastener, the method further comprising tightening the fastener after engaging the fastener with the slot.

15. The method of claim 13 wherein the slot includes alignment and coupling portions, and wherein engaging includes positioning the tab in the alignment portion of the slot and rotating one of said housings relative to the other of said housings to engage the tab with the coupling portion of the slot.

16. The method of claim 13 wherein at least one of the slot and the tab is tapered.

17. A variable speed blower assembly for a climate control system, the assembly comprising a variable speed electric motor having at least one end shield, an electronics housing, control electronics positioned in the electronics housing, and a plurality of tab-slot pairs, each pair including a tab located on one of the end shield and the electronics housing and a slot located on the other of said one of the end shield and the electronics housing, the tabs being positioned to engage the slots for aligning the electronics housing with the end shield.

18. The assembly of claim 17 wherein each tab comprises a fastener or a post.

19. The assembly of claim 18 wherein each slot includes an alignment portion and a coupling portion, each tab engaging the coupling portion of its corresponding slot after such tab is positioned in the alignment portion of such slot and the electronics housing is rotated relative to the end shield.

20. The assembly of claim 19 wherein the tab and the slot of each tab-slot pair have complementary tapered portions.

21. A climate control system comprising the assembly of claim 17.

22-24. (canceled)

25. The motor of claim 3 wherein the component is a blower.

26. The motor of claim 6 wherein the component is a blower.

27. The motor of claim 8 wherein the component is a blower.
